(19) United States
(12) Patent Application Publication
(10) Pub. No.: US 2009/0067010 A1
(43) Pub. Date: Mar. 12, 2009

(54) Beam Scanning Device of Image Forming Apparatus

(75) Inventor: Takahiro Hamanaka, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,406

(22) Filed: Sep. 9, 2008

Related U.S. Application Data
(60) Provisional application No. 60/971,542, filed on Sep. 11, 2007.

(51) Int. Cl. H04N 1/04

(52) U.S. Cl. 358/474

(57) ABSTRACT

In an embodiment of the invention, a detection pattern in the form of a right-angled isosceles triangle is used, and the detection pattern is scanned with a laser beam before occurrence of change with time and a laser beam after occurrence of change with time. The quantity of color shift in a sub scanning direction due to change with time is measured on the basis of the difference in scanning length between when the detection pattern is scanned with the laser beam before occurrence of change with time and when the detection pattern is scanned with the laser beam after occurrence of change with time. In accordance with the measured quantity of color shift, the writing start line of a laser beam from a laser oscillator is shifted.

### CROSS-REFERENCE TO RELATED APPLICATION

This application is based upon and claims the benefit of priority from U.S. provisional Application Ser. No. 60/971,542, filed on Sep. 11, 2007, the entire contents of which are incorporated herein by reference.

### TECHNICAL FIELD

The present invention relates to a beam scanning device of an image forming apparatus that adjusts a positional shift of an image caused by the lapse of time in a copy machine, a printer and the like.

### BACKGROUND

In an image forming apparatus such as a copy machine or printer, shift adjustment of an image is carried out generally at the time of warm-up in order to prevent a positional shift of the image or a color shift. Moreover, in the image forming apparatus, shift adjustment of an image is carried out to prevent a shift of the image caused by change with time during image formation. In order to adjust this shift of the image caused by change with time, a device that uses a temperature change with time in the image forming apparatus is conventionally employed. This conventional device readjusts the shift of the image in accordance with the quantity of shift of the image estimated from the temperature change in the image forming apparatus.

However, in the conventional shift adjustment of the image, if the quantity of shift of the image due to change with time does not correlate with the temperature change with time in the apparatus, shift adjustment of the image cannot be properly carried out. Therefore, despite the shift adjustment of the image, the shift of the image due to change with time cannot be corrected and the image quality may be lowered.

Thus, it is desired that a beam scanning device of an image forming apparatus is developed which is capable of adjusting a shift of an image highly accurately in accordance with the quantity of shift of the image due to change with time.

### SUMMARY

According to an aspect of the invention, the quantity of an actual image shift is detected and the shift of the image is thus adjusted highly accurately. This enables provision of a formed image of high image quality having no image shift despite change with time.

According to an embodiment of the invention, a beam scanning device of an image forming apparatus includes: a beam generating unit configured to output a beam; a scanning unit configured to scan, with the beam, a scanning target surface that rotationally travels; a photodetector unit that is arranged on a scanning line of the beam by the scanning unit and that has its output value changed when a passage position in a direction perpendicular to the scanning line of the beam changes; and a control unit configured to control the beam generating unit in accordance with a difference between a first output value of the photodetector unit at a first time and a second output value of the photodetector unit at a second time.

### DESCRIPTION OF THE DRAWINGS

FIG. 1 is a schematic configuration view showing a color copy machine according to a first embodiment of the invention;

FIG. 2 is a schematic explanatory view showing the positional relation between a laser exposure device and photoconductive drums according to the first embodiment of the invention;

FIG. 3 is a schematic explanatory view showing a photoconductive drum and a positional shift detecting unit according to the first embodiment of the invention;

FIG. 4 is an explanatory view showing a detection pattern according to the first embodiment of the invention;

FIG. 5 is a block diagram showing a control system adapted mainly for color shift correction according to the first embodiment of the invention;

FIG. 6 is an explanatory view showing the detection value of a detection pattern before change with time occurs, in order to measure the quantity of color shift according to the first embodiment of the invention;

FIG. 7 is an explanatory view showing the detection value of a detection pattern after change with time occurs, in order to measure the quantity of color shift according to the first embodiment of the invention;

FIG. 8 is a flowchart showing registration of change with time according to the first embodiment of the invention;

FIG. 9 is a top view showing a registration pattern on a carrying belt according to the first embodiment of the invention;

FIG. 10 is an explanatory view showing the setting of a tilt correction value of an image according to the first embodiment of the invention;

FIG. 11 is an explanatory view showing the setting of a correction value of a magnification error in a main scanning direction according to the first embodiment of the invention;

FIG. 12 is an explanatory view showing the setting of a correction value of a positional shift in a sub scanning direction according to the first embodiment of the invention;

FIG. 13 is an explanatory view showing the setting of a correction value of a positional shift in a main scanning direction according to the first embodiment of the invention;

FIG. 14 is a schematic explanatory view showing a photoconductive drum and a positional shift detecting unit according to a second embodiment of the invention;

FIG. 15 is an explanatory view showing a detection pattern according to the second embodiment of the invention;

FIG. 16 is an explanatory view showing the detection value of a detection pattern before change with time occurs, in order to measure the quantity of color shift according to the second embodiment of the invention;

FIG. 17 is an explanatory view showing the detection value of a detection pattern after change with time occurs, in order to measure the quantity of color shift according to the second embodiment of the invention;

FIG. 18 is a flowchart showing registration of change with time according to the second embodiment of the invention;

FIG. 19 is a schematic explanatory view showing a first application pattern of the invention;

FIG. 20 is a schematic explanatory view showing a second application pattern of the invention; and

FIG. 21 is a schematic explanatory view showing a modification of the invention.

### DETAILED DESCRIPTION

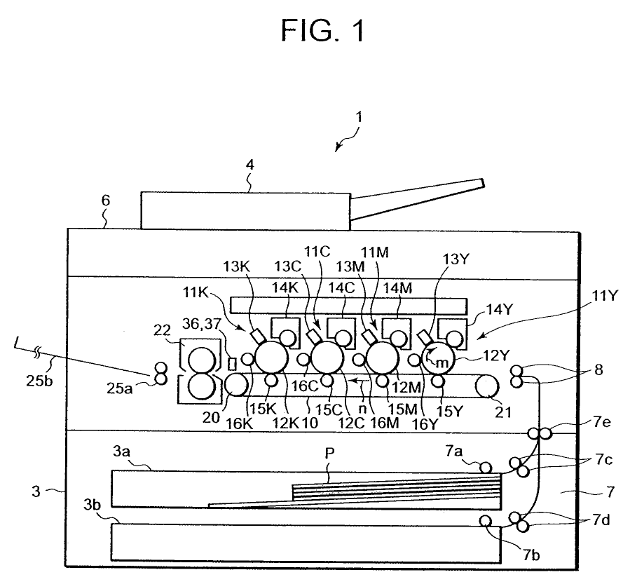

Hereinafter, a first embodiment of the invention will be described in detail with reference to the attached drawings. FIG. 1 is a schematic configuration view showing a four-drum tandem color copy machine 1, which is an image forming apparatus according to the embodiment of the invention. The color copy machine 1 has, at its top, a scanner unit 6 that scans an original supplied by an automatic document feeder 4. The color copy machine 1 has four image forming stations 11Y, 11M, 11C and 11K for yellow (Y), magenta (M), cyan (C) and black (K) arranged parallel to each other along a carrying belt 10.

The image forming stations 11Y, 11M, 11C and 11K have photoconductive drums 12Y, 12M, 12C and 12K, respectively, the surfaces of which are scanning target surfaces that rotationally travel. The photoconductive drums 12Y, 12M, 12C and 12K are arranged at equal spacing from each other along the carrying belt 10 supported by a driving roller 20 and a driven roller 21 and turned in the direction of an arrow n.

In the periphery of the photoconductive drums 12Y, 12M, 12C and 12K, chargers 13Y, 13M, 13C and 13K, developing devices 14Y, 14M, 14C and 14K, and photoconductor cleaners 16Y, 16M, 16C and 16K are arranged along the rotating direction (sub scanning direction) of the photoconductive drums, indicated by an arrow m respectively. The developing devices 14Y, 14M, 14C and 14K have a two-component developer including toner of different colors yellow (Y), magenta (M), cyan (C) and black (K), respectively, and carrier. The developing devices 14Y, 14M, 14C and 14K supply toner to electrostatic latent images on the photoconductive drums 12Y, 12M, 12C and 12K.

Between the chargers 13Y, 13M, 13C and 13K and the developing devices 14Y, 14M, 14C and 14K in the periphery of the photoconductive drums 12Y, 12M, 12C and 12K, each laser beam as a light beam is cast from a laser exposure device 17 and electrostatic latent images are formed on the photoconductive drums 12Y, 12M, 12C and 12K respectively. The electrostatic latent images on the photoconductive drums 12Y, 12M, 12C and 12K are developed by the developing devices 14Y, 14M, 14C and 14K respectively and then reach the position of the carrier belt 10.

A paper sheet P is taken out of a first or second paper feeding cassette 3a or 3b of a cassette mechanism 3 by a pickup roller 7a or 7b, then separated by separation carrying rollers 7c or 7d, and supplied to the carrying belt 10 via carrying rollers 7e and registration rollers 8 in a carrying path 7. The toner images formed on the photoconductive drums 12Y, 12M, 12C and 12K transferred to the paper sheet P carried on the carrying belt 10, by application of a transfer voltage of transfer rollers 15Y, 15M, 15C and 15K respectively. Thus, a color toner image is formed on the paper sheet P. After that, the paper sheet P, on which the color toner image is formed, has the toner image fixed by a fixing device 22 and thus has the color image completed. Then, the paper sheet P is discharged to a paper discharge tray 25b via paper discharge rollers 25a. After the end of transfer, residual toner on the photoconductive drums 12Y, 12M, 12C and 12K is cleaned by the photoconductor cleaners 16Y, 16M, 16C and 16K respectively. Thus, next printing becomes available.

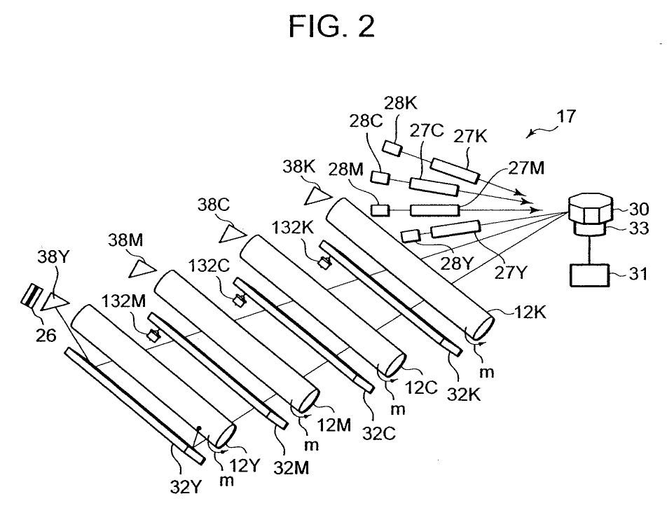

Now, the laser exposure device 17 will be described in detail. The laser exposure device 17 has laser oscillators 27Y, 27M, 27C and 27K, which are beam generating units that output each laser beam to scan the photoconductive drums 12Y, 12M, 12C and 12K respectively, as shown in FIG. 2. Each image signal frequency of the laser oscillators 27Y, 27M, 27C and 27K is, for example, 50 MHz. The laser oscillators 27Y, 27M, 27C and 27K are controlled by laser drivers 28Y, 28M, 28C and 28K respectively in accordance with data of each color component of image data scanned by the scanner unit 6.

Laser beams outputted from the laser oscillators 27Y, 27M, 27C and 27K are caused to scan the photoconductive drums 12Y, 12M, 12C and 12K respectively in the main scanning direction, which is the axial direction of the photoconductive drums 12Y, 12M, 12C and 12K, by a polygon mirror 30. The rotation axis of the photoconductive drums 12Y, 12M, 12C and 12K and the scanning direction of the laser beams are adjusted by using tilt mirrors 32Y, 32M, 32C and 32K respectively. The polygon mirror 30 and the tilt mirrors 32Y, 32M, 32C and 32K constitute a scanning unit.

The polygon mirror 30 is rotated at a constant velocity by a polygon mirror motor 33 that is driven by a polygon mirror motor driver 31. Thus, laser beams reflected by the polygon mirror 30 scan the photoconductive drums 12Y, 12M, 12C and 12K respectively in the main scanning direction at an angular velocity that is decided by the number of rotation of the polygon mirror motor 33.

The tilt mirrors 32Y, 32M, 32C and 32K are set with reference to the yellow (Y) tilt mirror 32Y. The other tilt mirrors 32M, 32C and 32K of magenta (M), cyan (C) and black (K) are adjusted in their tilt angle by tilt mirror motors 132M, 132C and 132K respectively so that these tilt mirrors are aligned with the yellow (Y) tilt mirror 32Y.

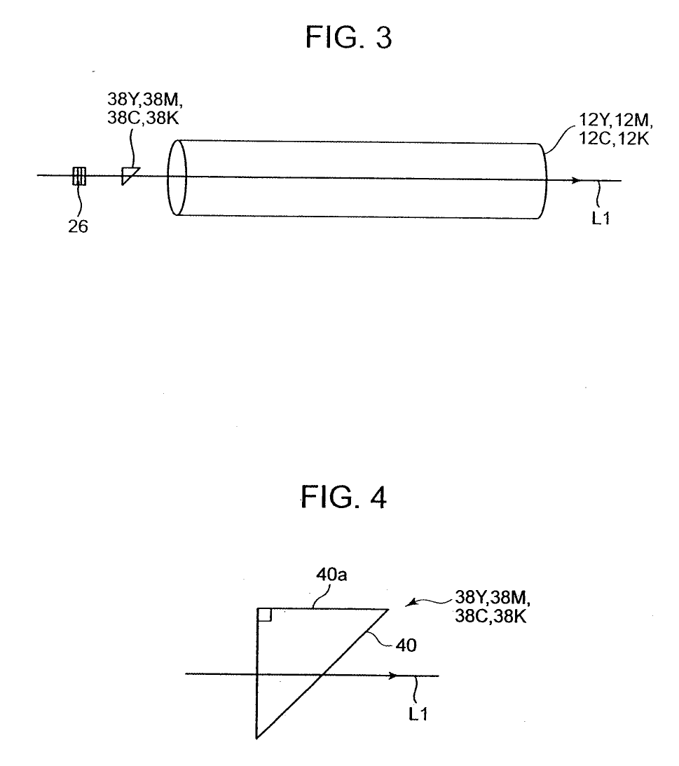

As shown in FIG. 3, on a scanning line (L1) of the laser beams that scan the photoconductive drums 12Y, 12M, 12C and 12K in the main scanning direction, a horizontal synchronizing signal detection sensor 26 is provided which detects the start of scanning in the main scanning direction by the laser beams outputted from the laser oscillators 27Y, 27M, 27C and 27K and outputs a horizontal synchronizing signal. The horizontal synchronizing signal detection sensor 26 outputs a horizontal synchronizing signal of the plural laser oscillators 27Y, 27M, 27C and 27K.

Moreover, positional shift detecting units 38Y, 38M, 38C and 38K which are photodetector units to detect a shift of a laser beam in the sub scanning direction are provided on the scanning line (L1) of the laser beams near the photoconductive drums 12Y, 12M, 12C and 12K respectively. Each of the positional shift detecting units 38Y, 38M, 38C and 38K is formed by a detection pattern 40 in the shape of a right-angled isosceles triangle, for example, as shown in FIG. 4. The detection pattern 40 is arranged in such a manner that its one side 40a forming right angles is parallel to the main scanning direction, which is the direction of the scanning line (L1) of the laser beams. The passage position of the laser beams passing through the detection pattern 40 changes in the sub scanning direction perpendicular to the scanning line (L1), the output value of the detection pattern 40 continuously changes.

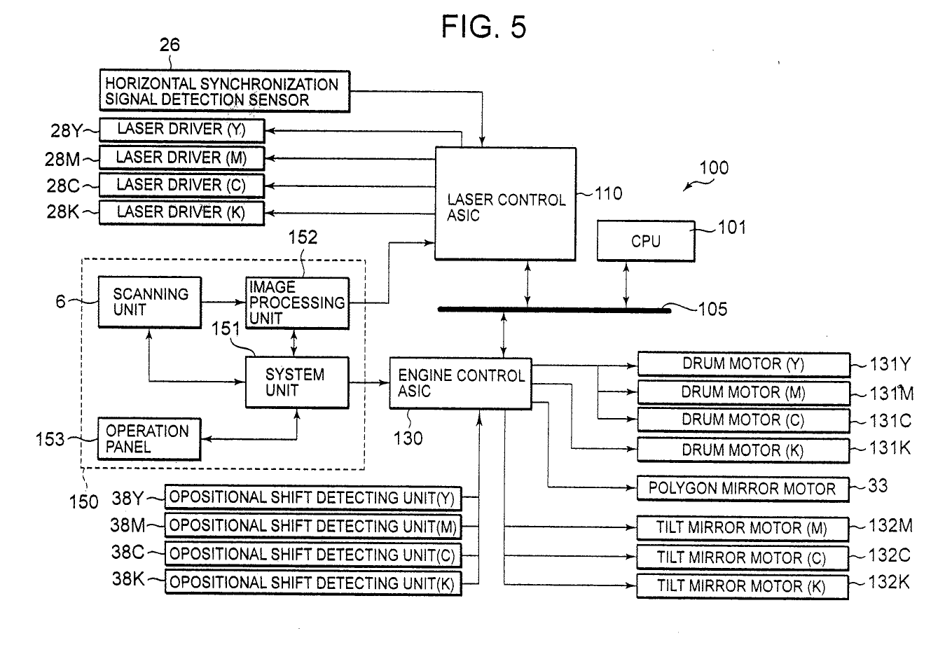

Next, correction of a color shift due to change with time will be described. FIG. 5 is a block diagram showing a control system 100 adapted mainly for color shift correction. In the control system 100, a laser control ASIC 110 and an engine control ASIC 130, which are control units, are connected to a CPU 101 that controls the entire color copy machine 1, via an input and output interface 105.

The laser control ASIC 110 controls the laser drivers 28Y, 28M, 28C and 28K. The horizontal synchronizing signal detection sensor 26 is connected to the laser control ASIC 110.

The positional shift detecting units 38Y, 38M, 38C and 38K are connected to the engine control ASIC 130. The engine control ASIC 130 controls drum motors 131Y, 131M, 131C and 131K that drive the photoconductive drums 12Y, 12M, 12C and 12K respectively, the polygon mirror motor 33, and the tilt mirror motor 132M, 132C and 132K.

Also, a print control unit 150 for forming an image in the color copy machine 1 is connected to the laser control ASIC 110 and the engine control ASIC 130. The print control unit 150 includes a system unit 151, an image processing unit 152, an operation panel 153, and the scanner unit 6.

In this color copy machine 1, images of four colors formed in the image forming stations 11Y, 11M, 11C and 11K are superimposed on the paper sheet P to provide a color image. Therefore, the color copy machine 1 carries out registration at the time of warm-up, for example, when power is turned on. Registration refers to control to correct a color shift between images of plural colors.

When carrying out registration, the color copy machine 1 operates in the same manner as in ordinary image formation, except for not supplying paper from the cassette mechanism 3. That is, front registration patterns 72Y, 72M, 72C and 72K and rear registration patterns 73Y, 73M, 73C and 73K formed on the photoconductive drums 12Y, 12M, 12C and 12K respectively are directly transferred onto the carrying belt 10. For registration, laser beams are oscillated from the laser oscillators 27Y, 27M, 27C and 27K, and registration patterns are formed on the carrying belt 10 at a predetermined count position from the horizontal synchronizing signal detection sensor 26. After that, the registration patterns of four colors on the carrying belt 10 are detected and the quantity of color shift from reference colors is measured. In accordance with the measured quantity of color shift, various corrections are made (including image tile correction, correction of a magnification error in the main scanning direction, correction of a shift in writing start position in the main scanning direction, and correction of a shift in writing start position in the sub scanning direction).

After registration is thus carried out, the color copy machine 1 carries out image formation. However, even after registration is carried out, a color shift of an image is generated by change with time in the color copy machine 1. This color shift of an image due to change with time occurs in the sub scanning direction, mainly caused by a characteristic change of the laser exposure device 17 due to a temperature change in the color copy machine 1. Therefore, in this embodiment, the quantity of color shift in the sub scanning direction due to change with time is measured and registration is carried out in accordance with the acquired quantity of color shift.

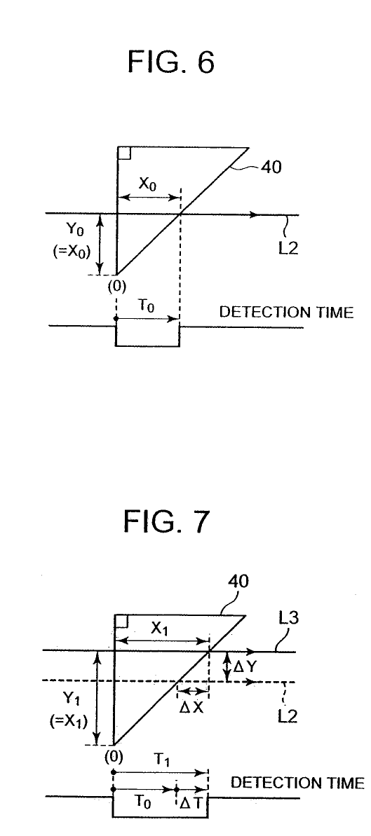

Next, a method of measuring the quantity of color shift due to change with time by using the detection pattern 40 will be described. When registration is carried out (before change with time occurs), each laser beam is oscillated from the laser oscillators 27Y, 27M, 27C and 27K to scan the detection pattern 40. At this time, a laser beam L2 passes a position that is Y₀ away from the starting point (0) of the detection pattern 40 in the sub scanning direction, for example, as shown in FIG. 6. The scanning length of the laser beam L2 on the detection pattern at this time is X₀. Each first detection time is T₀, which is a first output value of the positional shift detecting units 38Y, 38M, 38C and 38K.

After the lapse of a predetermined time from the execution of registration (after change with time occurs), each laser beam is oscillated from the laser oscillators 27Y, 27M, 27C and 27K to scan the detection pattern 40. At this time, a laser beam L3 passes a position shifted by ΔY [lines] from the passage position of the laser beam L2 in the sub scanning direction, for example, as shown in FIG. 7. The scanning length of the laser beam L3 on the detection pattern at this time is X₁=X₀+ΔX (where ΔX=ΔY). Each second detection time is T₁=T₀+ΔT, which is a second output value from the positional shift detecting units 38Y, 38M, 38C and 38K at the time.

Therefore, the quantity of color shift in the sub scanning direction due to change with time is measured as the difference ΔT between the first detection time and the second detection time. Based on the result of this measurement, registration of the change with time is carried out. Registration is carried out, for example, by shifting the oscillation start lines of the laser oscillators 27Y, 27M, 27C and 27K.

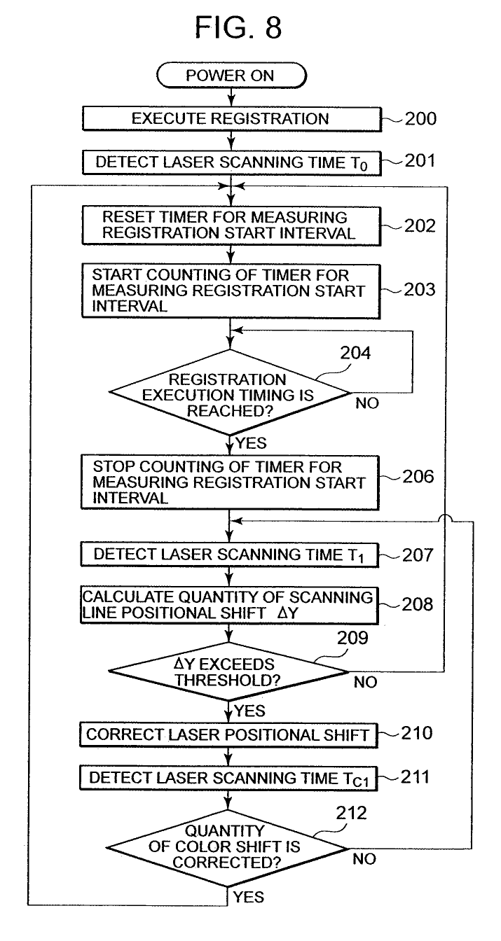

Next, registration when change with time occurs will be described with reference to the flowchart of FIG. 8. When power is turned on, the color copy machine 1 carries out warm-up and carries out registration in the same timing (Act 200). Registration at the time of warm-up is conventionally known (see, for example, JP-A-8-278680). Various conventionally known technique can be employed.

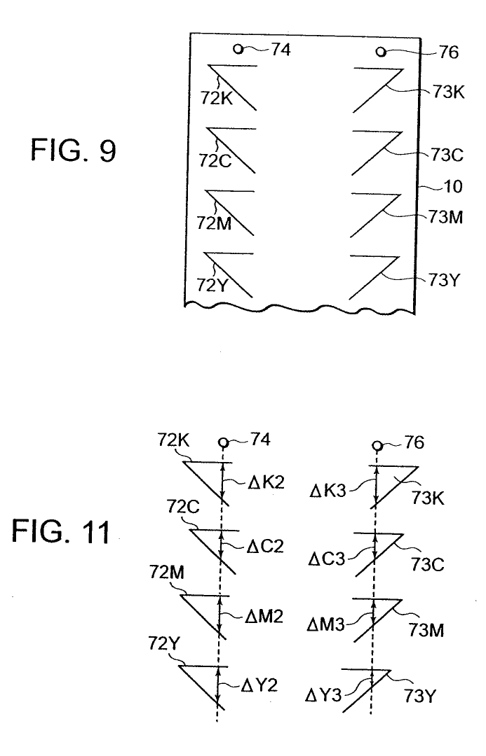

For example, as shown in FIG. 9, the front registration patterns 72Y, 72M, 72C and 72K and the rear registration patterns 73Y, 73M, 73C and 73K of yellow (Y) magenta (M), cyan (C) and black (K) in a predetermined shape are formed on the carrying belt 10 by the image forming stations 11Y, 11M, 11C and 11K, respectively. The formed front registration patterns 72Y, 72M, 72C and 72K are detected by a first pattern sensor 74. The rear registration patterns 73Y, 73M, 73C and 73K are detected by a second pattern sensor 76.

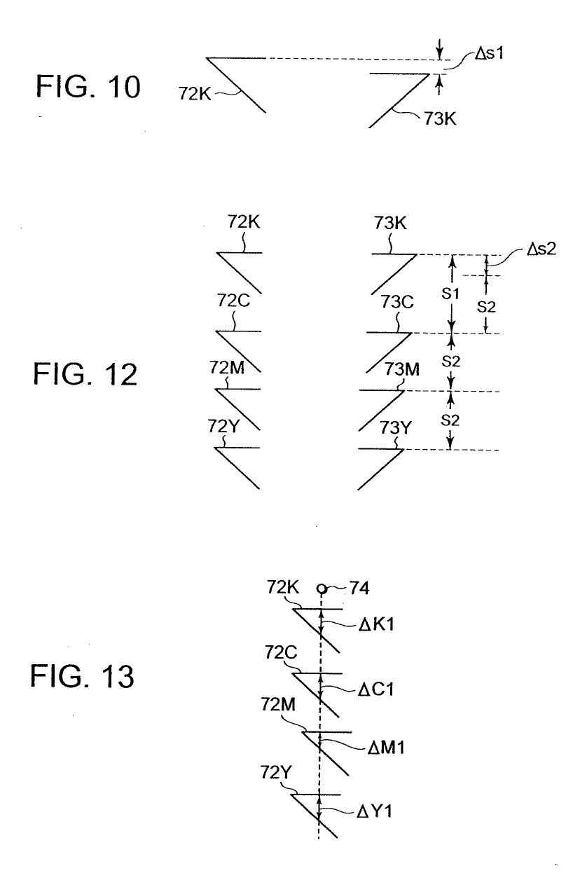

From the results of detection by the first and second pattern sensors 74 and 76, it is assumed that the output start timing is shifted by Δs1 between the front registration pattern 72K and the rear registration pattern 73K formed by the black (K) image forming station 11K, for example, as shown in FIG. 10. Thus, the CPU 101 determines that the axis of the black (K) photoconductive drum 12K and the scanning direction of the laser beam from the laser oscillator 27K are tilted with respect to each other. To correct this tilt of the photoconductive drum and the scanning direction of the laser beam, the CPU 101 sets the quantity of rotation of image data according to the quantity of tilt, as a correction value.

Alternatively, it is now assumed from the results of detection by the first and second pattern sensors 74 and 76 that the image forming stations 11Y, 1M, 11C and 11K have a magnification error in the main scanning direction, for example, as shown in FIG. 11. The CPU 101 determines this magnification error in the main scanning direction from the detected length of the front registration patterns 72K, 72C, 72M and 72Y and the rear registration patterns 73K, 73C, 73M and 73Y.

For example, it is assumed that the detected length of the front registration patterns 72K, 72C, 72M and 72Y is ΔK2, ΔC2, ΔM2 and ΔY2, respectively, and that the detected length of the rear registration patterns 73K, 73C, 73M and 73Y is ΔK3, ΔC3, ΔM3 and ΔY3, respectively. A correction value is set on the basis of the sum of the detected length on the front side and the detected length on the rear side for each color. That is, if (ΔK2+ΔK3)=(ΔC2+ΔC3)=(ΔM2+ΔM3)=(ΔY2+ΔY3) holds, it is determined that the image forming stations 11K, 11C, 11M and 11Y have the same image magnification in the main scanning direction. Therefore, the CPU 101 sets the quantity of enlargement or the quantity of reduction of image data as a correction value in order to eliminate a shift of image magnification in the main scanning direction.

Alternatively, it is now assumed from the results of detection by the first and second pattern sensors 74 and 76 that spacing S1 between the cyan (C) image forming station 11C and the black (K) image forming station 11K is different from spacing S2 between the other image forming stations in the sub scanning direction, for example, as shown in FIG. 12. The CPU 101 determines that the black (K) image forming station 11k has a positional shift in the sub scanning direction by ΔS2, which is the difference between the spacing S1 and spacing S2. Therefore, to correct this positional shift in the sub scanning direction, the CPU 101 sets the writing start timing in the sub scanning direction corresponding to ΔS2, as a correction value. At this time, a correction value that takes into account both the quantity of tilt in FIG. 10 and the quantity of positional shift in the sub scanning direction in FIG. 12 may be set as an image data correction value.

Alternatively, it is now assumed from the results of detection by the first and second pattern sensors 74 and 76 that the image forming stations 11Y, 11M, 11C and 11K have a positional shift in the main scanning direction as shown in FIG. 13, for example. The CPU 101 determines this positional shift in the main scanning direction from the detected length of the front registration patterns 72K, 72C, 72M and 72Y and the values of ΔK1, ΔC1, ΔM1 and ΔY1. Then, to correct this positional shift, the CPU 101 sets the quantity of shift of the image data writing start position in the main scanning direction in accordance with the quantity of positional shift of the image in the main scanning direction, as a correction value. The correction values are set to become ΔK1=ΔC1=ΔM1=ΔY1. These correction values are stored in a memory of the CPU 101.

After registration at the time of warm-up ends, in order to measure the above-described quantity of color shift due to change with time, laser beams are oscillated from the laser oscillators 27Y, 27M, 27C and 27K to scan the detection pattern 40. The positional shift detecting units 38Y, 38M, 38C and 38K detect the first detection time T₀, which is the first output value, shown in FIG. 6 (Act 201).

When warm-up ends, the color copy machine 1 becomes ready and image formation starts. In image formation, the CPU 101 reads out the collection value of positional shift in the main scanning direction, the correction value of positional shift in the sub-scanning direction and the correction value of the magnification error in the main scanning direction, of the correction values in the registration, from the memory of the CPU 101, and gives an instruction to the laser control ASIC 110. Thus, image data inputted from the scanner unit 6 is inputted to the laser control ASIC 110 via the image processing unit 152.

The laser control ASIC 110 gives an instruction to the laser drivers 28Y, 28M, 28C and 28K to control writing of image data from the image processing unit 152 in accordance with the correction values in the registration. Thus, the laser oscillators 27Y, 27M, 27C and 27K oscillate laser beams in timing controlled by a predetermined count from the horizontal synchronizing signal detection sensor 26 and thus form electrostatic latent images corresponding to the image data onto the photoconductive drums 12Y, 12M, 12C and 12K. After that, the electrostatic latent images on the photoconductive drums 12Y, 12M, 12C and 12K are developed, transferred onto the paper sheet P, and then fixed. Thus, the image is completed.

Meanwhile, based on when the first detection time T₀ is detected in Act 201 as a reference point, a time count unit of the CPU 101 resets the count value of a timer for starting registration according to change with time at predetermined intervals (Act 202). Next, the time count unit of the CPU 101 starts counting of the timer for starting the registration according to change with time at predetermined intervals (Act 203). When timing of executing registration according to change with time is reached on the basis of the count value of the timer (Yes in Act 204), the time count unit of the CPU 101 stops counting of a timer for measuring the interval between starts of registration according to change with time (Act 206).

Thus, the color copy machine 1 enters a registration mode according to change with time and starts registration according to change with time. When this is executed, laser beams are oscillated from the laser oscillators 27Y, 27M, 27C and 27K, and the polygon mirror 30 is rotated by driving of the polygon mirror motor 33 controlled by the engine control ASIC 130. The laser beams scan the detection pattern 40 and the positional shift detecting units 38Y, 38M, 38C and 38K detect the second detection time T₁, which is the second output value, shown in FIG. 7 (Act 207).

The time difference ΔT=|T₁−T₀| between the first detection time T₀ detected in Act 201 and the second detection time T₁ is calculated. The result of the calculation is converted to the scanning length ΔX. That is, ΔX=ΔT×F=|T₁-T₀|×F holds (where F represents the oscillation frequency of the laser oscillators 27Y, 27M, 27C and 27K). Since the shape of the detection pattern 40 is a right-angled isosceles triangle, the quantity of color shift ΔY [lines] in the sub scanning direction is equal to ΔX.

Therefore, the quantity of color shift in the sub scanning direction can be found from the following equation (Act 208).

ΔY[lines]=ΔX=ΔT×F=|T₁−T₀|×F

If the quantity of color shift in the sub scanning direction is large and ΔY [lines] exceeds a predetermined threshold (Yes in Act 209), this ΔY [lines] is used to correct the writing start timing in the sub scanning direction of the laser beams oscillated from the laser oscillators 27Y, 27M, 27C and 27K (Act 210). The direction of correction is calculated from the relation of magnitude between T₁ and T₀. If T₁>T₀ holds, the laser control ASIC 110 delays the oscillation of laser beams from the laser oscillators 27Y, 27M, 27C and 27K by ΔY [lines]. If T₁<T₀ holds, the laser control ASIC 110 advances the oscillation of laser beams from the laser oscillators 27Y, 27M, 27C and 27K by ΔY [lines].

The correction value of registration according to change with time (correction value of writing start timing in the sub scanning direction) is stored in the memory of the CPU 101. Thus, the correction value of the writing start timing in the sub scanning direction, set in the registration at the time of warm-up in Act 200, is rewritten into the correction value of the registration according to change with time.

If the quantity of color shift in the sub scanning direction is small in Act 208 and ΔY [lines] does not reach the predetermined threshold (No in Act 209), the writing start timing in the sub scanning direction is not corrected and processing returns to Act 202.

As the registration according to change with time ends in Act 210, the laser drivers 28Y, 28M, 28C and 28K drive the laser oscillators 27Y, 27M, 27C and 27K to oscillate laser beams with the writing start timing of the laser beams shifted by ΔY [lines]. The detection pattern 40 is scanned with the laser beams and the result of detection T_{C1} for confirmation from the positional shift detecting units 38Y, 38M, 38C and 38K is detected (Act 211). Comparison is made to determine whether the result of detection T_{C1} is close to the first detection time T₀ and whether the quantity of color shift in the sub scanning direction is corrected (Act 212). If the quantity of color shift ΔY [lines] in the sub scanning direction, found from the result of detection T_{C1} and first detection time T₀, exceeds a predetermined threshold (No in Act 212), processing returns to Act 207 to carry out registration again. On the other hand, if the quantity of color shift ΔY [lines] in the sub scanning direction does not reach the predetermined threshold (Yes in Act 212), it is confirmed that the color shift in the sub scanning direction is corrected, and processing returns to Act 202. After that, while the color copy machine 1 is on, Act 202 to Act 212 are repeated to carry out registration at predetermined intervals.

Specifically, for example, it is now assumed that the first detection time T₀ detected by the positional shift detecting unit 38Y in Act 201 is 0.10 [μsec] and the second detection time T₁ detected in Act 207 is 0.14 [μsec]If the image signal frequency F of the laser oscillator 27Y is 50 MHz, the quantity of color shift ΔY [lines] in the sub scanning direction calculated in Act 208 is expressed as follows.

ΔY[lines]=ΔX=ΔT×F=|T₁−T₀|×F=0.04[μsec]×50 [MHz]=2 [lines]

Therefore, this 2 [lines] is used as a correction value to delay the writing start timing of the laser oscillators 27Y, 27M, 27C and 27K by 2 [lines] in the sub scanning direction. Similarly, Act 207 to Act 212 are repeated for the positional shift detecting units 38M, 38C and 38K.

When the result is Yes in Act 212 and the registration according to change with time is completed, the color copy machine 1 is ready for start image formation. In image formation, the CPU 101 reads out the correction value rewritten in the registration according to change with time, from the memory of the CPU 101. Then, the laser control ASIC 110 instructs the laser drivers 28Y, 28M, 28C and 28K to control writing of image data from the image processing unit 152 in accordance with the correction values in the registration according to change with time. Thus, the laser oscillators 27Y, 27M, 27C and 27K oscillate laser beams in controlled timing and thus form electrostatic latent image corresponding to the image data onto the photoconductive drums 12Y, 12M, 12C and 12K. After that, the electrostatic latent images on the photoconductive drums 12Y, 12M, 12C and 12K are developed, transferred onto the paper sheet P and then fixed. Thus, the image is completed.

According to the first embodiment, after registration at the time of warm-up is carried out, the detection pattern 40 in the form of a right-angled isosceles triangle is scanned with the laser beam L2 before the occurrence of change with time and the laser beam L3 after the occurrence of change with time. The quantity of color shift in the sub scanning direction due to change with time is measured on the basis of the difference between the scanning length by which the laser beam L2 scans the detection pattern 40 and the scanning length by which the laser beam L3 scans the detection pattern 40. Based on the measured quantity of color shift, registration according to change with time is carried out. That is, registration is carried out in accordance with the quantity of color shift that actually occurs because of change with time, and the color shift is thus corrected. Consequently, when change with time occurs, color shift can be corrected highly accurately and a high-quality color image can be provided.

The registration according to change with time is carried out by shifting the writing start line of laser beams oscillated from the laser oscillators 27Y, 27M, 27C and 27K. Thus, the speed of execution of registration according to change with time can be increased.

Now, a second embodiment of the invention will be described. The second embodiment differs from the above first embodiment in the structure of the detection pattern. Since the other parts of the configuration are similar to those of the first embodiment, the same parts of the configuration as those described in the first embodiment are denoted by the same reference numerals and will not be described further in detail.

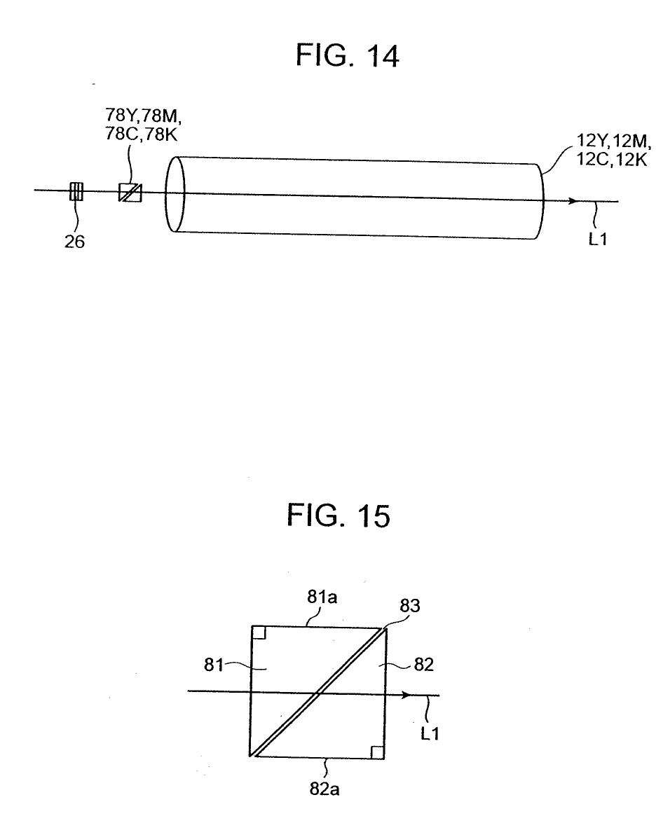

In the second embodiment, the quantity of color shift due to change with time is measured by using plural detection patterns. Thus, the accuracy of measuring the quantity of color shift is improved. That is, as shown in FIG. 14, positional shift detecting units 78Y, 78M, 78C and 78K, which are photodetectors and detect a shift of a laser beam in the sub scanning direction, are provided on a scanning line (L1) of a laser beam that scans the photoconductive drums 12Y, 12M, 12C and 12K in the main scanning direction.

Each of the positional shift detecting units 78Y, 78M, 78C and 78K includes a pair of detection patterns 81 and 82 having the same shape of a right-angled isosceles triangle and arranged symmetrically, as shown in FIG. 15. A slit 83 is provided between the detection pattern 81 and the detection pattern 82. The detection patterns 81 and 82 are arranged in such a manner that their one sides 81a and 82a forming right angles are parallel to the main scanning direction, which is the direction of the scanning line (L1) of the laser beam. When the passage position of the laser beam passing the detection patterns 81 and 82 changes in the sub scanning direction perpendicular to the scanning line (L1), increase or decrease direction in the output value is symmetrical between the detection pattern 81 and the detection pattern 82.

That is, when the laser beam changes in the sub scanning direction and the output value of the detection pattern 81 increases by ΔP1, the output value of the detection pattern 82 decreases by ΔP1. Conversely, when the output value of the detection pattern 81 decreases by ΔP2, the output value of the detection pattern 82 increases by ΔP2. Therefore, the quantity of color shift in the same timing can be measured by using the two patterns, that is, the detection pattern 81 and the detection pattern 82. As the average value of these output values is taken, for example, the output characteristic of the detection patterns 81 and 82 can be averaged.

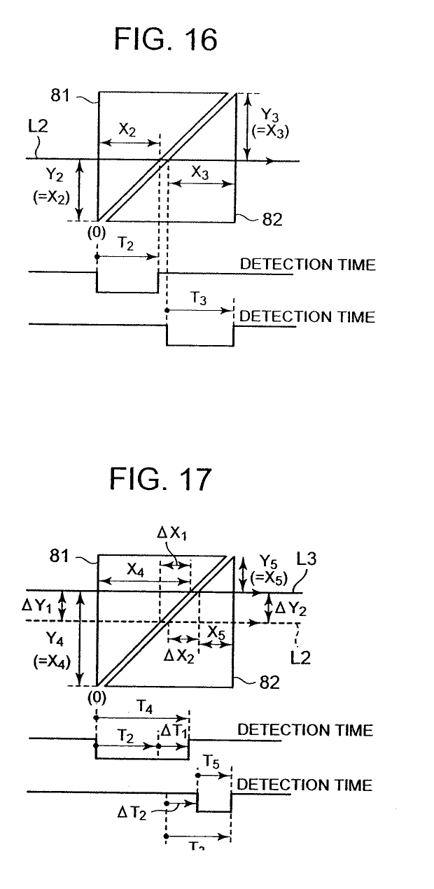

Next, a method of measuring the quantity of color shift by using the detection patterns 81 and 82 will be described. When registration is carried out (before change with time occurs), a laser beam is oscillated from the laser oscillators 27Y, 27M, 27C and 27K to scan the detection patterns 81 and 82. At this time, a laser beam L2 passes a position that is Y₂ away from the starting point (0) of the detection patterns 81 and 82 in the sub scanning direction, for example, as shown in FIG. 16. The scanning length of the laser beam L2 on the detection pattern 81 at this time is X₂. The scanning length of the laser beam L2 on the detection pattern 82 is X₃. A first detection time, which is a first output value of the positional shift detecting units 78Y, 78M, 78C and 78K at this time, is T₂ on the side of the detection pattern 81 and T₃ on the side of the detection pattern 82.

After the lapse of a predetermined time from the execution of registration (after change with time occurs), a laser beam is oscillated from the laser oscillators 27Y, 27M, 27C and 27K to scan the detection patterns 81 and 82. At this time, in the detection pattern 81, a laser beam L3 passes a position shifted by ΔY₁ [lines] from the passage position of the laser beam L2 in the sub scanning direction, for example, as shown in FIG. 17. In the detection pattern 82, the laser beam L3 passes a position shifted by ΔY₂ [lines] from the passage position of the laser beam L2.

The scanning length of the laser beam L3 on the detection pattern 81 at this time is X₄=X₂+ΔX₁ (where ΔX₁=ΔY₁). The scanning length of the laser beam L3 on the detection pattern 82 is X₅=X₃−ΔX₂ (where ΔX₂=ΔY₂). A second detection time that is a second output value of the positional shift detecting units 78Y, 78M, 78C and 78K with respect to the detection pattern 81 at this time is T₄=T₂+ΔT₁. A second detection time that is a second output value with respect to the detection pattern 82 is T₅=T₃-ΔT₂.

Therefore, the quantity of color shift in the sub scanning direction due to change with time, measured on the detection pattern 81, is the difference ΔT₁ between the first detection time and the second detection time. The quantity of color shift in the sub scanning direction due to change with time, measured on the detection pattern 82, is the difference ΔT₂ between the first detection time and the second detection time. Based on the result of this measurement, registration of the change with time is carried out.

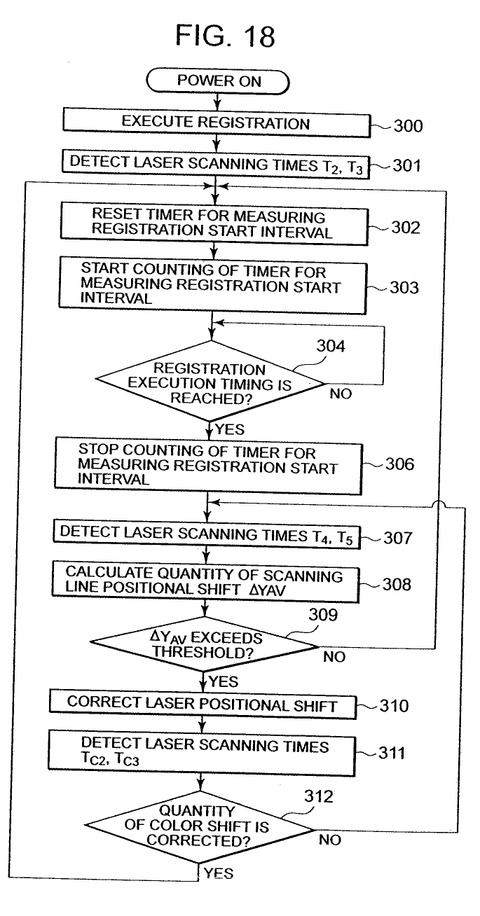

Next, registration when change with time occurs will be described with reference to the flowchart of FIG. 18. As in the first embodiment, when power is turned on, the color copy machine 1 carries out warm-up and carries out registration in the same timing (Act 300).

After the correction value in the registration at the time of warm-up is stored in the memory of the CPU 101 and Act 300 ends, in order to measure the above-described quantity of color shift due to change with time, the first detection times T₂ and T₃ of the detection patterns 81 and 82 shown in FIG. 16 are detected, respectively (Act 301).

When warm-up ends and the color copy machine 1 becomes ready, the color copy machine 1 starts image formation. Meanwhile, based on when the first detection times T₂ and T₃ are detected in Act 301 as a reference point, the count value of the timer is reset (Act 302). Next, the time count unit of the CPU 101 starts counting of the timer for starting registration according to change with time at predetermined intervals (Act 303). When timing of executing registration according to change with time is reached on the basis of the count value of the timer (Yes in Act 304), the timer stops counting for measuring the interval between starts of registration according to change with time (Act 306).

Thus, the color copy machine 1 starts registration according to change with time. When this is executed, laser beams are oscillated from the laser oscillators 27Y, 27M, 27C and 27K, and the polygon mirror 30 is rotated by driving of the polygon mirror motor 33 controlled by the engine control ASIC 130. Thus, the laser beams scan the detection patterns 81 and 82 and the positional shift detecting units 78Y, 78M, 78C and 78K detect the second detection time T₄ and T₅, shown in FIG. 17 (Act 307).

The time differences ΔT₁=|T₄−T₂| and ΔT₂=|T₅−T₃| between the first detection times T₂ and T₃ detected in Act 301 and the second detection times T₄ and T₅ are calculated. The results of the calculation are converted to the scanning lengths ΔX₁ and ΔX₂. That is, the following relations hold.

ΔX₁=ΔT₁×F=|T₄−T₂|×F and ΔX₂=ΔT₂×F=|T₅−T₃₁×F

Since the shape of the detection patterns 81 and 82 is a right-angled isosceles triangle, the quantity of color shift ΔY₁ [lines] in the sub scanning direction is equal to ΔX₁. Also, the quantity of color shift ΔY₂ [lines] in the sub scanning direction is equal to ΔX₂.

Therefore, the quantity of color shift in the sub scanning direction measured on the detection pattern 81 can be found from the following equation.

ΔY₁[lines]=ΔX₁=ΔT₁×F=|T₄−T₂|×F

The quantity of color shift in the sub scanning direction measured on the detection pattern 82 can be found from the following equation.

ΔY₂[lines]=ΔX₂=ΔT₂×F=|T₅−T₃₁×F

The quantity of color shift in the sub scanning direction acquired by averaging ΔY₁ [lines] and ΔY₂ [lines] is found from the following equation (Act 308).

ΔY_{AV}[lines]=(ΔY₁+ΔY₂)/2

If the quantity of color shift in the sub scanning direction acquired by averaging the two is large and ΔY_{AV} [lines] exceeds a predetermined threshold (Yes in Act 309), this ΔY_{AV} [lines] is used to correct the writing start timing in the sub scanning direction of the laser beams oscillated from the laser oscillators 27Y, 27M, 27C and 27K (Act 310). The direction of correction is calculated from the relation of magnitude between T₂ and T₄ or between T₃ and T₅.

The correction value of registration according to change with time (correction value of writing start timing in the sub scanning direction) is stored in the memory of the CPU 101. Thus, the correction value of the writing start timing in the sub scanning direction, set in the registration at the time of warm-up in Act 300, is rewritten into the correction value of the registration according to change with time.

If the averaged quantity of color shift in the sub scanning direction is small in Act 308 and ΔY_{AV} [lines] does not reach the predetermined threshold (No in Act 309), the writing start timing in the sub scanning direction is not corrected and processing returns to Act 302.

As the registration according to change with time ends in Act 310, the laser drivers 28Y, 28M, 28C and 28K drive the laser oscillators 27Y, 27M, 27C and 27K respectively to oscillate laser beams with the writing start timing of the laser beams shifted by ΔY_{AV}. The detection patterns 81 and 82 are scanned with the laser beams and the results of detection T_{C2} and T_{C3} for confirmation from the positional shift detecting units 78Y, 78M, 78C and 78K with respect to the detection patterns 81 and 82 are detected respectively (Act 311). Comparison is made to determine whether the results of detection T_{C2} and T_{C3} are close to the first detection times T₂ and T₃ and whether the quantity of color shift in the sub scanning direction is corrected (Act 312). If the average quantity of color shift ΔY_{AV} [lines] in the sub scanning direction, found from the results of detection T_{C2} and T_{C3} and the first detection times T₂ and T₃, exceeds a predetermined threshold (No in Act 312), processing returns to Act 307 to carry out registration again. On the other hand, if the average quantity of color shift ΔY_{AV} [lines] in the sub scanning direction does not reach the predetermined threshold (Yes in Act 312), it is confirmed that the color shift in the sub scanning direction is corrected, and processing returns to Act 302. After that, while the color copy machine 1 is on, Act 302 to Act 311 are repeated to carry out registration at predetermined intervals.

According to the second embodiment, the pair of detection patterns 81 and 82 in the form of symmetrically arranged right-angled isosceles triangles is used, and the detection patterns 81 and 82 are scanned with the laser beam L2 before the occurrence of change with time and the laser beam L3 after the occurrence of change with time. The quantities of color shift in the sub scanning direction due to change with time are measured on the basis of the differences between the scanning length by which the laser beam L2 scans the detection patterns 81 and 82 and the scanning length by which the laser beam L3 scans the detection patterns 81 and 82. An average of the quantity of color shift in the sub scanning direction acquired from the detection pattern 81 and the quantity of color shift in the sub scanning direction acquired from the detection pattern 82 is taken. Based on the averaged quantity of color shift, registration according to change with time is carried out. That is, as in the first embodiment, registration is carried out in accordance with the quantity of color shift that actually occurs because of change with time, and the color shift is thus corrected.

Consequently, when change with time occurs, color shift can be corrected highly accurately and a high-quality color image can be provided. Moreover, as the pair of detection patterns 81 and 82 is used, the averaged quantity of color shift can be measured and more accurate measurement results can be provided. Also, as in the first embodiment, the registration according to change with time is carried out by shifting the writing start line of laser beams oscillated from the laser oscillators 27Y, 27M, 27C and 27K. Thus, the speed of execution of registration according to change with time can be increased.

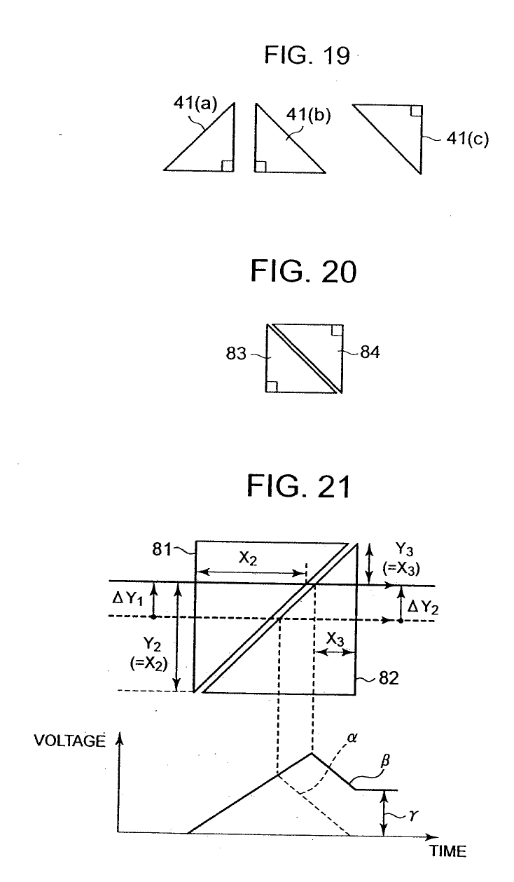

The invention is not limited to the above embodiments and various changes and modifications can be made without departing from the scope of the invention. For example, a correction value of image shift due to change with time, acquired from the detecting unit, can also be used, for example, for correction of positional shift of a beam due to change with time in a monochrome copy machine. Also, the detecting unit is not limited in its shape and arrangement as long as its output value is changed by change in the passage position of a beam. For example, with respect to the direction of arrangement of the detection patterns 40 in the first embodiment, detection patterns may be arranged symmetrically to the detection patterns 40, such as first application patterns 41(a), 41(b) and 41(c) shown in FIG. 19. Moreover, with respect to the direction of arrangement of the detection patterns 81 and 82 in the second embodiment, detection patterns may be arranged symmetrically to the detection patterns 81 and 82, such as second application patterns 83 and 84 shown in FIG. 20.

Furthermore, though the averaged quantity of color shift ΔY_{AV} [lines] in the sub scanning direction is calculated by using the shape of the pair of detection patterns 81 and 82 (right-angled isosceles triangles) in Act 308 of the second embodiment, the measurement of the quantity of color shift is not limited to this configuration. For example, as shown in a modification shown in FIG. 21, the quantity of color shift may be measured on the basis of an integral value of voltage while the laser beam L3 scans the detection pattern 81 and an integral value of voltage while the laser beam L3 scans the detection pattern 82. In FIG. 21, the output values of the pair of detection patterns 81 and 82 have the opposite polarity to each other. Here, in scanning with the laser beam L2 before the occurrence of change with time, the integral output of an integrator that integrates the voltage of the detection pattern 81 and the detection pattern 82 is 0, as indicated by a dotted line α. On the other hand, for example, in scanning with the laser beam L3 after the occurrence of change with time, the integral output of the integrator shows a characteristic as indicated by a solid line β. It is also possible to convert an output value γ at this time into the quantity of color shift and carry out registration according to change with time.

What is claimed is:

1. A beam scanning device of an image forming apparatus comprising:
a beam generating unit configured to output a beam;
a scanning unit configured to scan, with the beam, a scanning target surface that rotationally travels;
a photodetector unit that is arranged on a scanning line of the beam by the scanning unit and that has its output value changed when a passage position in a direction perpendicular to the scanning line of the beam changes; and
a control unit configured to control the beam generating unit in accordance with a difference between a first output value of the photodetector unit at a first time and a second output value of the photodetector unit at a second time.

2. The device according to claim 1, wherein the photodetector unit has a pair of detection patterns that are arranged symmetrically with predetermined spacing, one of the detection patterns having its output value increased and the other having its output value decreased when the passage position of the beam changes in the direction perpendicular to the scanning line.

3. The device according to claim 1, wherein the photodetector unit has at least one detection pattern in the form of a right-angled isosceles triangle in which one of two sides forming right angles is parallel to the scanning line.

4. The device according to claim 2, wherein the pair of detection patterns includes two right-angled isosceles triangles arranged in such a manner that one of two sides forming right angles is parallel to the scanning line.

5. The device according to claim 1, wherein the control unit performs sliding control of a scanning position of the beam on the scanning target surface, in the traveling direction of the scanning target surface.

6. The device according to claim 5, wherein the sliding control by the control unit is carried out by controlling output timing of the beam.

7. A beam scanning device of an image forming apparatus comprising:
plural beam generating units configured to output a beam;
a scanning unit configured to scan plural scanning target surfaces that rotationally travel, with each beam generated by the plural beam generating units, respectively;
plural photodetector units that are arranged on each scanning line of each of the beams by the scanning unit and that have their output value changed when a passage position in a direction perpendicular to the scanning line of each of the beams changes; and
a control unit configured to control each of the plural beam generating units in accordance with a difference between a first output value of each of the plural photodetector units at a first time and a second output value of each of the plural photodetector units at a second time.

8. The device according to claim 7, wherein each of the plural photodetector units has a pair of detection patterns that are arranged with predetermined spacing, one of the detection patterns having its output value increased and the other having its output value decreased when the passage position of each of the beams changes in the direction perpendicular to the scanning line.

9. The device according to claim 7, wherein each of the plural photodetector units has at least one detection pattern in the form of a right-angled isosceles triangle in which one of two sides forming right angles is parallel to each of the scanning lines.

10. The device according to claim 8, wherein the pair of detection patterns includes two right-angled isosceles triangles arranged in such a manner that one of two sides forming right angles is parallel to each of the scanning lines.

11. The device according to claim 7, wherein the control unit performs sliding control of a scanning position of each of the beams on the plural scanning target surfaces, in the traveling direction of the plural scanning target surfaces.

12. The device according to claim 11, wherein the sliding control by the control unit is carried out by controlling output timing of each of the beams.

13. The device according to claim 7, wherein the plural scanning target surfaces are plural image carriers on which an image is formed by each of the beams, and
the first time is a time when color shift of each of the images formed on the plural image carriers is corrected at the time of warm-up, and the second time is a time after the lapse of a predetermined period from the first time.

14. Abeam scanning method for an image forming apparatus comprising:
scanning a photodetector unit with a beam that is outputted from a beam generating unit at a first time and that scans a rotationally traveling scanning target surface;
scanning the photodetector unit with a beam that is outputted from the beam generating unit at a second time and that scans the scanning target surface;
finding a difference between a first output value from the photodetector unit at the first time and a second output value of the photodetector unit at the second time; and
controlling the beam generating unit in accordance with the difference.

15. The method according to claim 14, wherein the output value of the photodetector unit changes when a scanning position of the beam changes in a direction perpendicular to the scanning direction of the beam.

16. The method according to claim 15, wherein the photodetector unit has a pair of detection patterns that are arranged parallel to the scanning direction with predetermined spacing, one of the detection patterns having its output value increased and the other having its output value decreased when the passage position of the beam changes in the direction perpendicular to the scanning direction.

17. The method according to claim 15, wherein the photodetector unit has at least one detection pattern in the form of a right-angled isosceles triangle in which one of two sides forming right angles is parallel to the scanning direction.

18. The method according to claim 16, wherein the pair of detection patterns includes two right-angled isosceles triangles arranged in such a manner that one of two sides forming right angles is parallel to the scanning direction.

19. The method according to claim 14, wherein in the control of the beam generating unit in accordance with the difference, output timing of the beam in the traveling direction of the scanning target surface is controlled.

20. The method according to claim 14, wherein the scanning target surface is an image carrier, and the first time is a time when color shift of an image formed on the image carrier is corrected at the time of warm-up, and the second time is a time after the lapse of a predetermined period from the first time.
